(19) United States
(12) Patent Application Publication
(10) Pub. No.: US 2009/0052058 A1
(43) Pub. Date: Feb. 26, 2009

(54) OPTICAL ELEMENT MOLDING METHOD AND OPTICAL ELEMENT

(76) Inventor: Hajime YAMANAKA, Saitama-shi (JP)

Correspondence Address: BIRCH STEWART KOLASCH & BIRCH, PO BOX 747, FALLS CHURCH, VA, 22040-0747, US

(21) Appl. No.: 12/181,377

(22) Filed: Jul. 29, 2008

(30) Foreign Application Priority Data
Aug. 22, 2007 (JP) P2007-215748

(51) Int. Cl. G02B 9/04

(52) U.S. Cl. 359/754; 264/1.7

(57) ABSTRACT

An optical element is molded by placing at least two glass materials between a pair of molding dies having optical-function transfer surfaces, a total volume of the two glass materials being same as that of the optical element, the two glass materials being made of a same material and being formed to individually come in contact with centers of the optical-function transfer surfaces when they are pressed; and by heating and pressing the glass materials using the pair of molding dies. Thereby, closed spaces are not formed between the optical-function transfer surfaces and the glass materials coming in contact with the centers of the optical-function transfer surfaces. Therefore, it is possible to reduce a load of the molding process while preventing an appearance defect of the optical element by applying just a single cycle of a placing process, a transferring (heating and pressing) process and a cooling process.

### CROSS-REFERENCE TO RELATED APPLICATIONS

This application is based upon and claims the benefit of priority from the Japanese Patent Application No. 2007-215748 filed on Aug. 22, 2007; the entire contents of which are incorporated herein by reference.

### BACKGROUND OF THE INVENTION

1. Technical Field

The invention relates to an optical element molding method and an optical element.

2. Description of the Related Art

Recently, various optical lenses for use in an optical system have been developed as optical devices get smaller and lighter and have multiple functions. In particular, in an apparatus such as DVD (Digital Versatile Disc) which uses a lens for an optical disc including a pickup lens for use in the optical apparatus, a demand for high NA of the optical lens has been increased. Moreover, in a Blu-ray disc (optical disc having high capacity) which has recently been spread, a blue-violet laser having a shorter wavelength is used together with a high NA lens to realize high-density data storage. A demand for further high NA optical lens is expected to be increased.

As a method of molding the optical lens (hereinafter, referred to as “an optical element”), there has widely been used a press molding method of molding the optical element from a glass material with a pair of molding dies each having a transfer surface containing an optical-function transfer surface and a guide mold into which the molding dies are inserted. In the press molding method, a glass material is placed in a first molding die, the glass material is pressed by the first molding die and a second molding die in order to transfer the transfer surfaces in a state where the glass material is being heated and softened, and the glass material is cooled to form a desired optical element.

Here, an optical function surface of the optical element indicate a range up to the outside of the optical element including a range of an effective diameter (range within which effective light rays pass in the optical system) of the optical element. If a molding process only for the range of the effective diameter is used, it would be difficult to process the optical element in accordance with a design shape to realize a function of the optical element. Therefore, the optical function surface of the optical element means a range that is molded in accordance with a predetermined design shape to realize the function of the optical element, as well as the range of the effective diameter.

A “curvature radius” in the case where the optical element has aspheric shape refers to a curvature radius of the optical element in the vicinity of an optical axis of the optical element. Also, as to a surface shape of a glass material and a transfer surface of a molding die, the curvature radii of them refers to curvature radii of portions corresponding to the vicinity of the optical axis of the optical element, as well.

In order to satisfy the demand for high NA using a single lens, the thickness of the circumferential portion of the optical element has to be thin since it is necessary to increase the effective diameter of the optical element and to use even a portion having a steep slope in the lens surface as the effective diameter. For that reason, in order to ensure the thickness of the circumferential portion necessary for the process, the thickness of the vicinity of the optical axis of the optical element has to be thick. Thus, the volume of the glass material increases. As a result, if the curvature radius of the glass material becomes larger than that of the transfer surface, a closed space may be formed between the glass material and the transfer surface in a state where the glass material is placed in a first molding die. For that reason, a recess may be easily generated in the optical function surface of the molded optical element.

In order to solve these problems, JP 2004-10456 A describes a press molding method of molding an optical element from a glass material which is divided into plural portions having a small diameter. In the press molding method disclosed in JP 2004-10456 A, first, a first glass material is placed in a first molding die, the first glass material is pressed by the first and second molding dies in a state where the first glass material is being heated and softened, to transfer a transfer surface of the first molding die; and the first glass material is cooled to a predetermined temperature. Then, a second glass material is placed on the first glass material and again pressed in a state where the first and second glass materials are being heated and softened, to transfer the transfer surfaces of the first and second molding dies. Then, the first and second glass materials are cooled to a predetermined temperature. In this publication, the problem regarding the recess is solved by dividing the glass material into the plural glass portions having the small diameter since the first glass material can be placed so that the closed space between the first glass material and the transfer surface of the first molding die is not formed when a first placing process of placing the first glass material is performed.

However, in the press molding method described in JP 2004-10456 A, the glass material is subjected to the placing process, the transferring process, and the cooling process in two cycles to mold the optical element. Therefore, the forming process becomes complicated, thereby hindering improvement of productivity. Moreover, since the glass material is subjected to the transferring process in two cycles, haze, bubbles, or the like may be easily generated in the outer appearance of the optical element due to heating performed in the re-transferring process.

Moreover, in order to satisfy the demand for the high NA, a small curvature radius and an optical function surface of an aspheric configuration are often required. Therefore, generally, the glass material is different in shape from the transfer surface of the molding die. For that reason, in the transferring process, deformation of the glass material occurs in order to absorb the shape difference between the glass material and the molding die. Then, if the deformation of the glass material in the transferring process exceeds an allowable deformation degree, crack, chipping or the like easily occurs. Thus, improving fluidity of the glass material may be considered. However, the haze, the bubble, or the like may be easily generated in the appearance of the optical element due to the heating, like in the re-transferring.

### SUMMARY OF THE INVENTION

The invention has been made in view of the above circumstances, provides a new or improved optical element molding method that can reduce a load of a molding process while preventing an appearance defect of an optical element, and provides the optical element.

According to an aspect of the invention, a method of molding an optical element, includes: placing at least two glass materials between a pair of molding dies each having an optical-function transfer surface, a total volume of the glass materials being same as that of the optical element to be molded, the glass materials being made of a same material, and the glass materials being formed so as to individually come in contact with centers of the optical-function transfer surfaces when the glass materials are pressed; and heating and pressing the glass materials using the pair of molding dies to mold the optical element.

With the method described above, the optical-function transfer surfaces are transferred by placing the at least two glass materials between the pair of molding dies each having the optical-function transfer surface so as to individually come in contact with the centers of the optical-function transfer surfaces when they are pressed, and by heating and pressing the glass materials using the pair of molding dies. In this way, a closed space is not formed between each optical-function transfer surface and the glass material coming in contact with the center of each optical-function transfer surface. Therefore, it is possible to reduce a load of the molding processes while preventing the appearance defect such as generation of a recess by applying just a single cycle of the placing process, the transferring (heating and pressing) process, and the cooling process to the glass materials. Also, since the transferring process is performed just in one cycle, it is possible to prevent haze, bubbles, or the like that may occur on the appearance of the optical element in the re-transferring process.

Also, the at least two glass materials may be formed in different shapes from each other. With the method described above, since the plural glass materials are formed in the different shapes, the glass materials can be easily placed in the molding dies. Accordingly, it is possible to prevent the closed spaces from being formed between the optical-function transfer surfaces and the glass materials.

Also, of the at least two glass materials, the glass material which is placed on the optical-function transfer surface having a relatively smaller curvature radius may be formed in a spherical shape. With the method described above, the glass material having the spherical shape is placed on the optical-function transfer surface having the relatively smaller curvature radius. Accordingly, it is possible to prevent the closed spaces from being formed between the optical function surfaces and the glass materials by employing the glass material having the curvature radius smaller than that of the optical functional transfer surface.

Also, the at least two glass materials may be placed so that the at least two glass materials are in contact with each other on center axes of the respective glass materials. With the method described above, since pressurizing forces of the molding dies are smoothly transmitted to the plural glass materials through the contact on the center axes, the glass materials can be smoothly deformed. In this way, since the excessive deformation of the glass materials is prevented, it is possible to prevent the appearance defect such as crack, chipping, or the like.

Also, the pair of molding dies may include an upper mold and a lower mold, and at least one of the glass materials, which does not come in contact with the optical-function transfer surface of the lower mold, may be placed so as to be in contact with a portion of the lower mold other than the optical-function transfer surface of the lower mold. With the method described above, since the glass material is placed to be in contact with the portion of the lower mold other than the optical-function transfer surface of the lower mold, the glass materials are stably placed in the pair of molding dies. In this way, it is possible to prevent excessive deformation which is caused by decentration between the glass materials or between the glass materials and the molding dies, and tilting of the glass materials, for example.

Also, the pair of molding dies may include an upper mold and a lower mold that are slidable inside a guide mold, and at least one of the glass materials, which does not come in contact with the optical-function transfer surface of the lower mold, may be placed so as to be in contact with the guide mold. With the method described above, since the glass materials are placed to be in contact with the guide mold, the glass materials are stably placed in the one pair of molding dies. In this way, it is possible to prevent excessive deformation which is caused by decentration between the glass materials or between the glass materials and the molding dies, and tilting of the glass materials, for example.

Also, in comparison with a sphere having a same total volume as that of the optical element, the optical element having a curvature radius smaller than that of the sphere may be molded. With the method described above, in the optical element having the curvature radius smaller than that of the sphere having the same total volume of that of the optical element, that is, in the optical element having the relatively smaller curvature radius, it is possible to reduce a load of the molding processes while preventing the appearance defect such as a transfer failure, haze, bubbles, or the like, which is generated due to the formation of the closed spaces between the molding dies and the glass materials.

According to another aspect of the invention, an optical element that is manufactured by: placing at least two glass materials between a pair of molding dies each having an optical-function transfer surface, a total volume of the glass materials being same as that of the optical element to be molded, the glass materials being made of a same material, and the glass materials being formed so as to individually come in contact with centers of the optical-function transfer surfaces when the glass materials are pressed, and heating and pressing the glass materials using the pair of molding dies to mold the optical element.

With the configuration described above, the optical element is molded by Placing the at least two glass materials between the pair of molding dies having the optical-function transfer surfaces so as to individually come in contact with the centers of the optical-function transfer surfaces when they are pressed, and by heating and pressing the glass materials using the pair of molding dies. In this way, the closed spaces are not formed between the optical-function transfer surfaces and the glass materials coming in contact with the centers of the optical-function transfer surfaces. Therefore, it is possible to reduce a load of the molding processes while preventing the appearance defect such as a recess by applying just a single cycle of the placing process, the transferring (heating and pressing) process, and the cooling process to the glass materials.

Also, in comparison with a sphere having a same total volume as that of the optical element, the optical element having a curvature radius smaller than that of the sphere may be molded. With the configuration described above, in the optical element having the curvature radius smaller than that of the sphere having the same total volume of that of the optical element, that is, in the optical element having the relatively smaller curvature radius, it is possible to reduce the load of the molding process while preventing the appearance defect such as a transfer failure, haze, bubbles, or the like that are generated due to the formation of the closed spaces between the molding dies and the glass materials.

As described above, the invention can provide the optical element molding method that can reduce a load of the molding processes while preventing the appearance defect of the optical element and provide the optical element.

### BRIEF DESCRIPTION OF THE DRAWINGS

FIG. 1 is a diagram illustrating a molding apparatus that is used in a method of molding an optical element according to an embodiment of the invention.

FIGS. 2A to 2D are diagrams for explaining the method of molding the optical element according to the embodiment.

FIGS. 3A to 3C are diagrams for explaining a method of molding an optical element according to a modified example 1.

FIGS. 4A and 4B are diagrams for explaining a method of molding an optical element according to a modified example 2.

### DETAILED DESCRIPTION OF EMBODIMENTS OF THE INVENTION

Hereinafter, embodiments of the invention will be described in detail with reference to the accompanying drawings. Also, the same reference numerals are given to constituent elements having the substantially same function in this specification and the drawings, and the duplicate description thereon will be omitted.

### Description of Embodiments

Hereinafter, a method of molding an optical element according to an embodiment of the invention will be described.

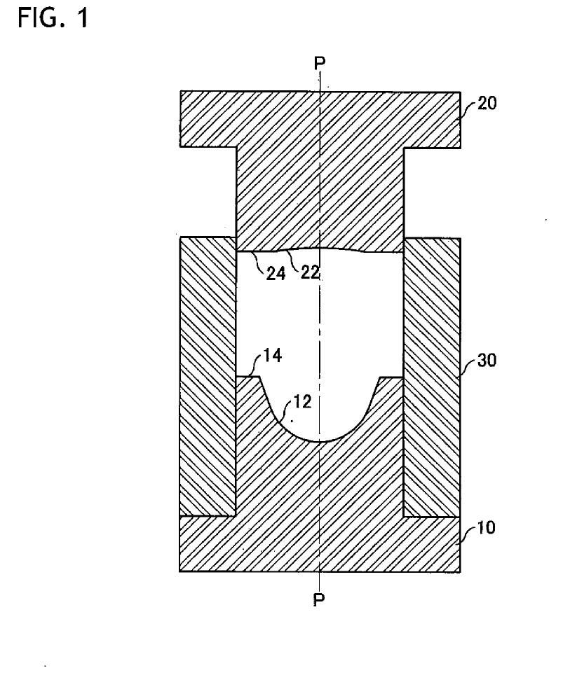

FIG. 1 is a diagram illustrating a molding apparatus that is used in a method of molding an optical element according to this embodiment.

The method of molding the optical element according to this embodiment, as shown in FIG. 1, uses a first molding die 10 and a second molding die 20, which constitute a pair of molding dies, and a guide mold 30. The first molding die 10 includes a first transfer surface (including an optical-function transfer surface) 12 for transferring a convex-shape molding surface containing the optical function surface to a glass material and a second transfer surface 14 for transferring a shape of an edge, a flange, and the like to the outer edge of the convex-shape molding surface. The second molding die 20 includes a third transfer surface (including an optical-function transfer surface) 22 for transferring a convex-shape molding surface containing the optical function surface to a glass material and a fourth transfer surface 24 for transferring a molding surface having a shape of an edge, a flange, or the like to the outer edge of the convex-shape molding surface. The pair of molding dies 10 and 20 are inserted into the guide mold 30 so as to be slidable along the inner surface thereof.

In the molding dies 10 and 20 shown in FIG. 1, the convex-shape molding surfaces are transferred by the first transfer surface 12 and the third transfer surface 22. Also, the molding surfaces having the shape of the edge, the flange, and the like are transferred by the second transfer surface 14 and the fourth transfer surface 24. However, the transfer surfaces may be formed in a desired shape in accordance with the shape of the optical element to be molded.

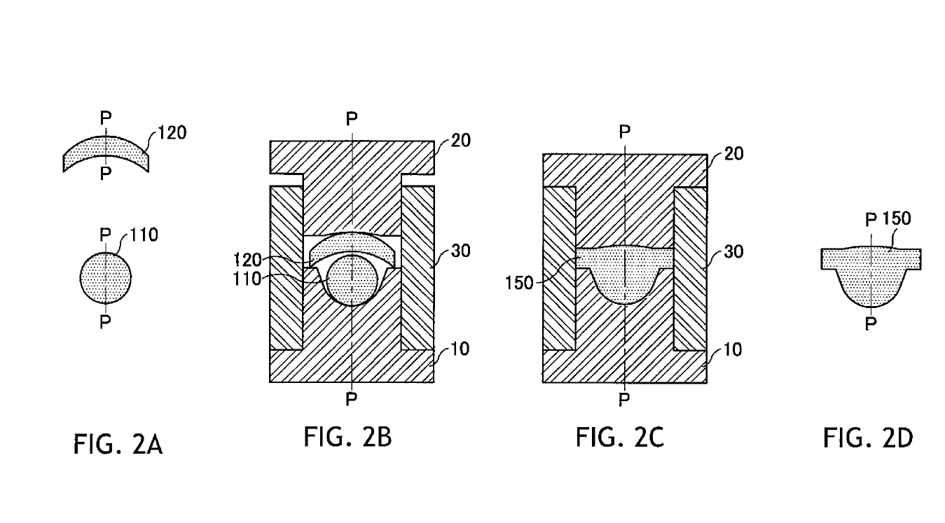

The method of molding the optical element according to the embodiment will be described. FIG. 2 is a diagram for explaining the method of molding the optical element according to this embodiment. FIGS. 2A to 2D show the shapes of glass materials, a placing process, a transferring process, and a molded optical element, respectively. In the following description, the detailed configuration of the molding dies 10 and 20 will be described with reference back to FIG. 1.

Particularly, it is preferable that the method of molding the optical element according to this embodiment is applied to a process of molding an optical element 150 including an optical function surface having a curvature radius smaller than that of a sphere having the same total volume as that of the optical element 150, that is, a process of molding the optical element 150 having a relatively smaller curvature radius of the optical function surface. Hereinafter, the case where molded is the optical element 150 having the relatively smaller curvature radius of the optical function surface will be described. However, the method of molding the optical element according to this embodiment may also be applied to a process of molding an optical element having a relatively larger curvature radius of the optical function surface.

When the optical element 150 is to be molded, a first glass material 110 and a second glass material 120 are first prepared, as shown in FIG. 2A.

In this embodiment, the first glass material 110 has a spherical shape, and the second glass material 120 has a concave shape on one side and a convex shape on the other side. In the method of molding the optical element according to this embodiment, the first glass material 110 and the second glass material 120 are made of the same material, and the total volume of the first and second glass materials 110, 120 is configured so as to be substantially the same as that of the optical element 150 to be molded.

In the method of molding the optical element according to this embodiment, as the first glass material 110 and the second glass material 120, glass materials (pre-form) which have a spherical shape or which have a concave shape on one side and a convex shape on the other side, that is, which can be obtained relatively easily may be used. Accordingly, it is possible to reduce a load of the molding process and reduce manufacturing cost by obtaining the glass materials 110 and 120 relatively easily, in comparison with the case where a glass material having a special shape is used. However, in the method of molding the optical element according to this embodiment, the invention is not limited to the illustrated shapes of the glass materials 110 and 120, but other shapes may be used.

As shown in FIG. 2B, the glass materials 110 and 120 are placed or arranged in the first molding die 10 with the first molding die 10 being inserted into the guide mold 30.

The first glass material 110 is formed so that, in the state where the first glass material 110 is placed in the first molding die 10, the first glass material 110 has a surface which is on the convex-portion side where the surface faces the first transfer surface 12 and which is formed so as to have a curvature radius smaller than that of the first transfer surface 12 and that the first glass material 110 comes in contact with the first transfer surface 12 on a center axis P. With this configuration, the first glass material 110 can be placed in the first molding die 10 so that a closed space is not formed between the first transfer surface 12 and the first glass material 110.

The second glass material 120 is formed so that, in the state where the second glass material 120 is placed in the molding dies 10 and 20, the end portions of the second glass material 120 comes in contact with the second transfer surface 14. Also, when the second glass material 120 is to be placed, an appropriate positioning unit may be used for centering, if necessary. In this way, the second glass material 120 does not form a closed space between the second glass material 120 and the first glass material 110, and is stably placed in the molding dies 10 and 20 because the second glass material 120 is in contact with the second transfer surface 14.

The second glass material 120 is formed so that, in the state where the second molding die 20 is inserted into the guide mold 30, the convex surface of the second glass material 120 comes in contact with the third transfer surface 22 on the center axis P. With this configuration, the second glass material 120 is placed in the molding dies 10 and 20 so that a closed space is not formed between the third transfer surface 22 and the second glass material 120.

In the example shown in FIG. 2, a closed space is formed between the first molding die 10 and the glass materials 110 and 120 in the placing process. However, in the transferring process, when it is started to apply pressure in the vicinity of the center axis P of the glass materials 110 and 120, and then an initial deformation occurs, the closed space is opened. Even if the closed space remains, a transfer defect portion which occurs due to the remaining closed space appears in a portion corresponding to the outside of the optical function surface of the optical element. Accordingly, the transfer defect portion does not affect the function of the optical element 150.

Then, the second molding die 20 is inserted into the guide mold 30, and in a state where the glass material 110, 120 are heated and softened at a temperature equal to or higher than the yield point of the material, pressure is applied to the glass materials 110 and 120 by the molding dies 10 and 20 so that the transfer surfaces 12, 14, 22, and 24 are transferred, as shown in FIG. 2C. Thereby, molding surfaces corresponding to the first transfer surface 12, the second transfer surface 14, the third transfer surface 22, and the fourth transfer surface 24 of the molding dies 10 and 20 are transferred to the glass materials 110 and 120.

In the previous placing process, the glass materials 110 and 120 are placed in the molding dies 10 and 20 so that closed spaces are not formed between the first transfer surface 12 and the first glass material 110, between the first glass material 110 and the second glass material 120, and between the second glass material 120 and the third transfer surface 22. Then, when the pressure is applied in this state, the first transfer surface 12 and the first glass material 110, the first glass material 110 and the second glass material 120, and the second glass material 120 and the third transfer surface 22 are in close contact with each other in the center portions thereof and are kept being spaced in the edge portions from each other by a predetermined appropriate gap. Thereby, formation of a recess is suppressed.

The first transfer surface 12 and the first glass material 110 are placed or arranged in the molding dies 10 and 20 so as to come in contact with each other on the center axis P. Also, the second glass material 120 and the third transfer surface 22 are placed or arranged in the molding dies 10 and 20 so as to come in contact with each other on the center axis P. The second glass material 120 is stably placed in the molding dies 10 and 20 by coming in contact with the second transfer surface 14. Accordingly, in the transferring process, the pressuring force of the molding dies 10 and 20 is smoothly transmitted to the glass materials 110 and 120 through the contact on the center axis P, thereby smoothly deforming the glass materials 110 and 120. Thereby, it is possible to prevent an appearance defect such as crack, chipping or the like that is caused excessive deformed due to decentration between the glass materials 110 and 120 or between the glass materials 110 and 120 and the molding dies 10 and 20 and due to tilting of the glass materials 110 and 120.

Finally, the glass materials 110 and 120 are cooled to a predetermined temperature equal to or less than the transformation temperature of the material of the glass materials 110 and 120, and the first molding die 10 and/or the second molding die 20 are separated from the guide mold 30. As shown in FIG. 2D, the optical element 150 is taken out.

As described above, the method of molding the optical element according to this embodiment of the invention has been described. According to the method of molding the optical element, the at least two glass materials 110 and 120 is placed between the pair of molding dies 10 and 20 having the first and third transfer surfaces 12 and 22 (optical-function transfer surfaces). The at least two glass materials 110 and 120 are formed so as to individually come in contact with the centers of the respective first transfer surface 12 and third transfer surface 22 when the first and second glass materials 110 and 120 are pressed. Then, the two glass materials 110 and 120 are heated and pressed, to transfer the first transfer surface 12 and the third transfer surface 22. Thereby, the closed spaces are not formed in the first transfer surface 12 and the third transfer surface 22 and between the glass materials 110 and 120 coming in contact with each other on the center axis of the respective first transfer surface 12 and third transfer surface 22. Therefore, it is possible to reduce the load of the molding processes while preventing the appearance defect such as formation of a recess, by applying to the glass materials 110 and 120 just a single cycle of the placing process, the transferring (heating and pressing) process, and the cooling process. Also, it is possible to prevent haze or bubbles caused by the re-transferring process from occurring on the appearance of the optical element because the transferring process is performed just in one cycle.

### EXPLANATION OF MODIFIED EXAMPLES

Hereinafter, various modified examples of the above-described embodiment will be described. Methods of molding an optical element according to modified examples 1 and 2 will be described below. The duplicate description will be omitted.

### Modified Example 1

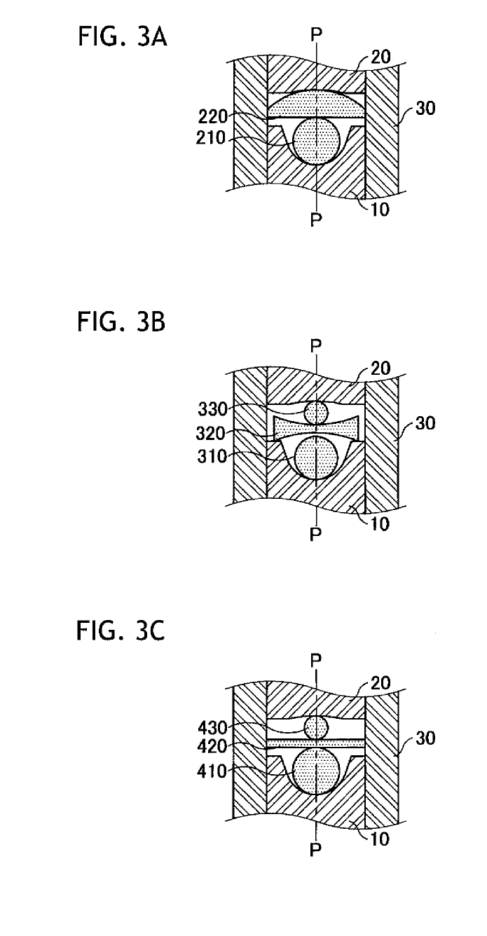

FIG. 3 is a diagram for explaining a method of molding an optical element according to the modified example 1. FIGS. 3A to 3C show three modified examples of the placing process of the method of molding the optical element. In the following description, the detailed configuration of molding dies 10 and 20 will be described with reference back to FIG. 1.

In the modified example shown in FIG. 3A, a first glass material 210 is formed in a spherical shape, and a second glass material 220 is formed in a convex shape on one side and a flat shape on the other side. In the modified example shown in FIG. 3B, a glass material is divided into three pieces. A first glass material 310 and a third glass material 330 are formed in a spherical shape, and a second glass material 320 is formed in a concave shape on both sides. In the modified example shown in FIG. 3C, a first glass material 410 and a third glass material 430 are formed in a spherical shape, and a second glass material 420 is formed in a flat shape.

In the modified example shown in FIG. 3A, the glass materials 210 and 220 are placed in the molding dies 10 and 20 so that closed spaces are not formed between the first transfer surface 12 and the first glass material 210, between the first glass material 210 and the second glass material 220, and between the second glass material 220 and the third transfer surface 22. Also, the glass materials 210 and 220 are placed or arranged in the molding dies 10 and 20 so that the first transfer surface 12 and the first glass material 210, the first glass material 210 and the flat surface of the second glass material 220, and the convex surface of the second glass material 220 and the third transfer surface 22 come in contact with each other on the center axis P thereof, respectively. Furthermore, the second glass material 220 is stably placed in the molding dies 10 and 20 because the end portions of the second glass material 220 are in contact with the sliding surface of the guide mold 30.

In the modified example shown in FIG. 3B, the glass materials 310, 320, and 330 are placed in the molding dies 10 and 20 so that closed spaces are not formed between the first transfer surface 12 and the first glass material 310, between the first glass material 310 and the second glass material 320, between the second glass material 320 and the third glass material 330, and between the third glass material 330 and the third transfer surface 22. Also, the glass materials 310, 320, and 330 are placed or arranged in the molding dies 10 and 20 so that the first transfer surface 12 and the first glass material 310, the first transfer surface 12 and the concave surface of the second glass material 320, the concave surface of the second glass material 320 and the third glass material 330, and the third glass material 330 and the third transfer surface 22 come in contact with each other on the center axis P thereof; respectively. Furthermore, the second glass material 320 is stably placed in the molding dies 10 and 20 because the end portions of the second glass material 320 are in contact with the second transfer surface 14.

The modified example shown in FIG. 3C is similar to the modified example shown in FIG. 3B, except that the second glass material 420 is stably placed in the molding dies 10 and 20 due to the contact between the end portions of the second glass material 420 and the sliding surface of the guide mold 30.

According to the method of molding the optical element related to the modified example 1, the at least two glass materials 210 and 220; 310, 320, and 330; and 410, 420, and 430 are placed between the pair of molding die 10, 20 having the first and third transfer surfaces 12, 22 (optical-function transfer surfaces). The at least two glass materials 210 and 220; 310, 320, and 330; and 410, 420, and 430 are formed so as to individually come in contact with the centers of the first transfer surface 12 and third transfer surface 22 when the glass materials are pressed. Then, the glass materials are heated and pressed, to transfer the first transfer surface 12 and the third transfer surface 22. Thereby, the closed spaces are not formed between (i) the first transfer surface 12 and the third transfer surface 22 and (ii) the glass materials 210 and 220; 310 and 330; and 410 and 430 coming in contact with each other on the center axis of the first transfer surface 12 and third transfer surface 22, respectively. Therefore, it is possible to reduce the load of the molding process while preventing the appearance defect such as a recess by applying to the glass materials 210 and 220; 310, 320, and 330; and 410, 420, and 430 just a single cycle of the placing process, the transferring (heating and pressing) process, and the cooling process.

### Modified Example 2

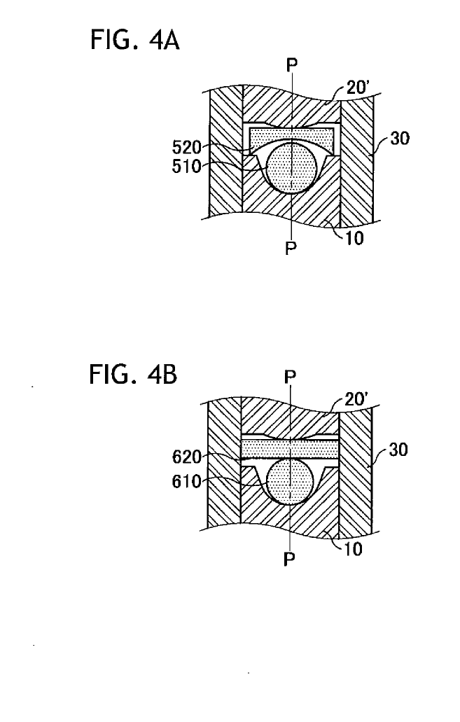

FIG. 4 is a diagram for explaining a method of molding an optical element according to a modified example 2. FIGS. 4A and 4B show two modified examples of a placing process of the method of molding the optical element.

In the following description, the detailed configuration of molding dies 10 and 20′ will be described, basically with reference back to FIG. 1. In a molding apparatus used in the method of molding the optical element according to the modified example 2, the second molding die 20′ including a third transfer surface 22′ for transferring a concave molding surface including an optical function surface is used, instead of the convex forming surface including the optical function surface.

In the modified example shown in FIG. 4A, a first glass material 510 is formed in a spherical shape, and a second glass material 520 is formed in a concave shape on one side and a flat shape on the other side. In the modified example shown in FIG. 4B, a glass material 610 is formed in a spherical shape and a glass material 620 is formed in a flat shape on both sides.

In the modified example shown in FIG. 4A, the glass materials 510 and 520 are placed in the molding dies 10 and 20′ so that closed spaces are not formed between the first transfer surface 12 and the first glass material 510 and between the second glass material 520 and the third transfer surface 22′. Also, the glass materials 510 and 520 are placed or arranged in the molding dies 10 and 20′ so that the first transfer surface 12 and the first glass material 510 come in contact with each other on the center axis P and the second glass material 520 and the third transfer surface 22′ come in contact with each other on the center axis P. Furthermore, the glass material 520 is stably placed in the molding dies 10 and 20′ due to the contact between the end portions of the second glass material 520 and the second transfer surface 14.

The modified example shown in FIG. 4B is similar to the modified example shown in FIG. 4A, except that the second glass material 620 is stably placed in the molding dies 10 and 20′ due to the contact between the end portions of the second glass material 620 and the sliding surface of the guide mold 30.

According to the method of molding the optical element related to the modified example 2, like the above-described embodiment, the at least two glass materials 510 and 520; and 610 and 620 are placed between the pair of molding dies 10 and 20′ having the first transfer surface 12 and the third transfer surface 22′ (optical-function transfer surface), respectively. The at least two glass materials 510 and 520; and 610 and 620 are formed so as to individually come in contact with the center of the respective first transfer surface 12 and third transfer surface 22′ when the glass materials are pressed. The glass materials are heated and pressed, to transfer the first transfer surface 12 and the third transfer surface 22′. Thereby, the closed spaces are not formed between (i) the first transfer surface 12 and the third transfer surface 22′ and (ii) the glass materials 510 and 520; and 610 and 620 coming in contact with each other on the center axis of the respective first transfer surface 12 and third transfer surface 22′. Therefore, it is possible to reduce the load of the molding process while preventing the appearance defect such as a recess by applying to the glass materials 510 and 520; and 610 and 620 just a single cycle of the placing process, the transferring (heating and pressing) process, and the cooling process.

As described above, the embodiments of the invention have been described with reference to the accompanying drawings, but the invention is not limited thereto. It is apparent to one skilled in the art that the invention may be modified or corrected into various forms within the scope of the technical spirit recited claims. Also, it should be understood that the modified examples also belong to the technical scope of the invention.

In the foregoing description, it has been described that two or three glass materials come in contact with each other on the center axis P (including the case where a part of the two or three glass materials do not come in contact with each other). Also, it has been described that the two glass materials 110 and 120; 210 and 220; 310 and 330; 410 and 430; 510 and 520; and 610 and 620 come in contact with the first transfer surface 12 and the third transfer surface 22 or 22′, respectively, on the center axis P thereof when they are pressed. However, the method of molding the optical element is also applicable to the case where the two or three glass materials 110 and 120; 210 and 220; 310, 320, and 330; 410, 420, and 430; 510 and 520; and 610 and 620 come in contact with each other, respectively, with slightly being deviated from the center axis P, or do not come in contact with each other, respectively, with a gap being interposed therebetween. Also, the method of molding the optical element is also applicable to the case where the two glass materials 110 and 120; 210 and 220; 310 and 330; 410 and 430; 510 and 520; and 610 and 620 come in contact with the first transfer surface 12 and the third transfer 22 or 22′, respectively, with being deviated from the center axis P.

In the foregoing description, the various shapes or sizes of the glass materials have been shown, but the shapes or sizes are just examples.

What is claimed is:

1. A method of molding an optical element, comprising:
placing at least two glass materials between a pair of molding dies each having an optical-function transfer surface, a total volume of the glass materials being same as that of the optical element to be molded, the glass materials being made of a same material, and the glass materials being formed so as to individually come in contact with centers of the optical-function transfer surfaces when the glass materials are pressed; and
heating and pressing the glass materials using the pair of molding dies to mold the optical element.

2. The method according to claim 1, wherein the at least two glass materials are formed in different shapes from each other.

3. The method according to claim 1, wherein of the at least two glass materials, the glass material which is placed on the optical-function transfer surface having a relatively smaller curvature radius is formed in a spherical shape.

4. The method according to claim 1, wherein the at least two glass materials are placed so that the at least two glass materials are in contact with each other on center axes of the respective glass materials.

5. The method according to claim 1, wherein
the pair of molding dies includes an upper mold and a lower mold, and
at least one of the glass materials, which does not come in contact with the optical-function transfer surface of the lower mold, is placed so as to be in contact with a portion of the lower mold other than the optical-function transfer surface of the lower mold.

6. The method according to claim 1, wherein
the pair of molding dies include an upper mold and a lower mold that are slidable inside a guide mold, and
at least one of the glass materials, which does not come in contact with the optical-function transfer surface of the lower mold, is placed so as to be in contact with the guide mold.

7. The method according to claim 1, wherein in comparison with a sphere having a same total volume as that of the optical element, the optical element having a curvature radius smaller than that of the sphere is molded.

8. An optical element that is manufactured by
placing at least two glass materials between a pair of molding dies each having an optical-function transfer surface, a total volume of the glass materials being same as that of the optical element to be molded, the glass materials being made of a same material, and the glass materials being formed so as to individually come in contact with centers of the optical-function transfer surfaces when the glass materials are pressed, and
heating and pressing the glass materials using the pair of molding dies to mold the optical element.

9. The optical element according to claim 8, wherein in comparison with a sphere having a same total volume as that of the optical element, the optical element having a curvature radius smaller than that of the sphere is molded.
